(19) United States
(12) Patent Application Publication
(10) Pub. No.: US 2004/0237311 A1
(43) Pub. Date: Dec. 2, 2004

(54) Soft serve beverage utensil

(76) Inventors: Kirk Brown, Teaneck, NJ (US); Aleah Brown, Teaneck, NJ (US)

Correspondence Address: HEDMAN & COSTIGAN, P.C., 1185 Avenue of the Americas, New York, NY, 10036, US

(21) Appl. No.: 10/445,577

(22) Filed: May 27, 2003

(51) Int. Cl. A47J 43/28

(52) U.S. Cl. 30/141; 30/324

(57) ABSTRACT

A hand held eating and drinking utensil that is constructed to be used for the dual purpose of serving as a spoon for eating and as a straw for drinking. The utensil is in the form of a spoon having a handle with a bowl for eating food as a spoon and having a handle that is hollow throughout containing a straw or for providing the insertion of a straw to suck liquid or bits of food through the handle into a child's mouth. A decorative figure or design can be attached to the handle of the utensil while providing an amusing device for the child to play with either with or without any food or liquid thereon. The device can be appropriately sanitized by cleaning and replacement with a new straw after each use.

### FIELD OF THE INVENTION

The present invention relates to a spoon-straw hand held eating and drinking utensil and, more particularly, to a spoon that can be operated as a straw that optionally can be replaced after each use.

### DESCRIPTION OF THE PRIOR ART

During meals, people often require two different utensils for eating and drinking. For example, a bowl of cereal with milk having small size pieces of cereal can be consumed with the aid of a spoon and straw. People, especially children, are faced with the dilemma of which utensil to use. Moreover, children need encouragement at times to eat their meal or merely desire to experience a more pleasurable eating experience during meal time. In addition, consumption of certain desserts, such as milkshakes and ice cream sodas, are more facilitated with a spoon and a straw.

Often, promotional, advertising and decorative items are placed on children's eating utensils to help and encourage their eating habits. These utensils must be designed so that they can be packaged easily, inexpensively manufactured, and must be safe in the hands of children. Furthermore, such products must meet stringent requirements for food applications.

In the past, various types of utensils have been developed. For instance, in U.S. Pat. No. 6,463,662 entitled “Spoon and Straw Combination Device” discloses a hand held eating utensil wherein a hollow straw portion is permanently affixed to the head of the spoon at a sharp angle. The use of a hollow straw portion in the '662 patent, however, renders the device relatively flimsy. Thus the spoon portion is unable to scoop heavy or hard food items, such as ice cream in an ice cream soda without bending or breaking. Moreover, the requirement to permanently affix the straw to the spoon makes it hard to clean the inside of the straw, and inside the base of the spoon liquid and food may collect harboring bacteria and/or other pathogens. Likewise, U.S. Pat. No. 5,946,807 entitled “Novelty Spoon” discloses a hand held eating utensil that has a figure member positioned on the handle of the utensil. The figure can be removed and a portion of the handle of the spoon which acts as a straw can be pulled apart length-wise.

As illustrated by the prior art devices, there has never been disclosed a hand held utensil configured to operate both as a spoon for eating hard and heavy items and a straw for drinking that can be easily sanitized. Accordingly, applicant's invention provides a hand held eating and drinking utensil that can be operated both as a spoon and as a straw and overcomes the drawbacks of the prior art.

### SUMMARY OF THE INVENTION

It is the primary object of the present invention to provide a novel construction of a hand held utensil that can be used for the dual purpose of serving as a spoon for eating and as a straw for drinking. Further, the claimed invention provides for the insertion and removal of standard plastic straws or a straw of any suitable material that can be easily inserted within the invention. In so doing, the device can be properly sanitized for each use.

Another object of the invention is to provide space on the hand held eating and drinking utensil for promotional use with popular licensed characters or themes. The promotional aspect of the device induces the child to eat or drink his food and still provide an amusing device for the child to play with either with or without any food or liquid thereon.

Still another object of the invention is to provide a hand held eating and drinking utensil that can be inexpensively made, packaged in a flat configuration, and easily assembled by the user.

Other objects of the present invention will become more apparent to persons having ordinary skill in the art to which the present invention pertains from the following description taken in conjunction with the accompanying drawings.

### BRIEF DESCRIPTION OF THE DRAWINGS

FIG. 1 is a side perspective view of a preferred embodiment of the present invention showing the spoon with a removable or permanent straw as it remains concealed within an underside channel of the handle.

FIG. 2 is a bottom view of a preferred embodiment of the present the invention with a permanent or single use straw that is located in a channel configuration on the underside of the handle and proceeds through an open area within the bowl of the spoon.

FIG. 3 is a top view of a preferred embodiment of the present invention wherein the handle displays a permanently or temporarily affixed decorative figure and promotional writing.

### DETAILED DESCRIPTION OF THE INVENTION

The present invention is a novel construction for a hand held utensil that can be used for the dual purpose of serving as a spoon for eating and as a straw for drinking. The utensil basically comprises three parts: a solid handle, a spoon bowl, and a straw portion. The spoon bowl is further provided with a straw opening for communicating with the hollow portion of the straw. The straw is connected to the solid handle by any affixation means known to those skilled in the art, such as, but not limited to, adhesive or as a single molded construction in the case of a permanently attached straw, or an enclosed channel in the case of a removable straw.

The handle is solid and elongated and may be constructed of any suitable plastic commonly used for producing plastic spoons. The handle is solid and of sufficient thickness to enable the spoon to be used in consuming relatively hard and heavy foods without deforming or breaking such as, but not limited to, ice cream. Preferably the handle is ergonomically designed for holding and has a channel-like configuration to the underside. The channel-like configuration underneath the handle aids in concealing the straw from a top side view as the straw passes from the end of the handle until it appears in the opening within the bowl of the spoon where the handle connects, and prevents the straw from being compressed during grasping of the spoon. The channel may also provide support for the straw, and in the case of a non-permanent straw, provide a means for attachment to the solid handle.

The bowl is formed at the forward handle portion such that the handle and bowl preferably continue in a straight line. The top side of the handle provides an area for promotional use or the addition of a decorative figure. A further embodiment of the invention provides for the idea of a permanently attaching the straw to the handle, preferably the underside, if desired. The straw portion has a length greater than the length of the handle, thereby assuring that the straw can be accessed by the mouth of the user without the mouth contacting the handle.

The user can grasp any portion of the handle for eating or drinking. If a decorative figure is added to the handle, besides acting as an amusement for a child user, the figure also provides the child with a larger handle for easier grasping of the utensil. The hand held utensil can then either be used in a scooping manner to collect food or inserted into a liquid such that the liquid can be sucked through the straw and into the user's mouth.

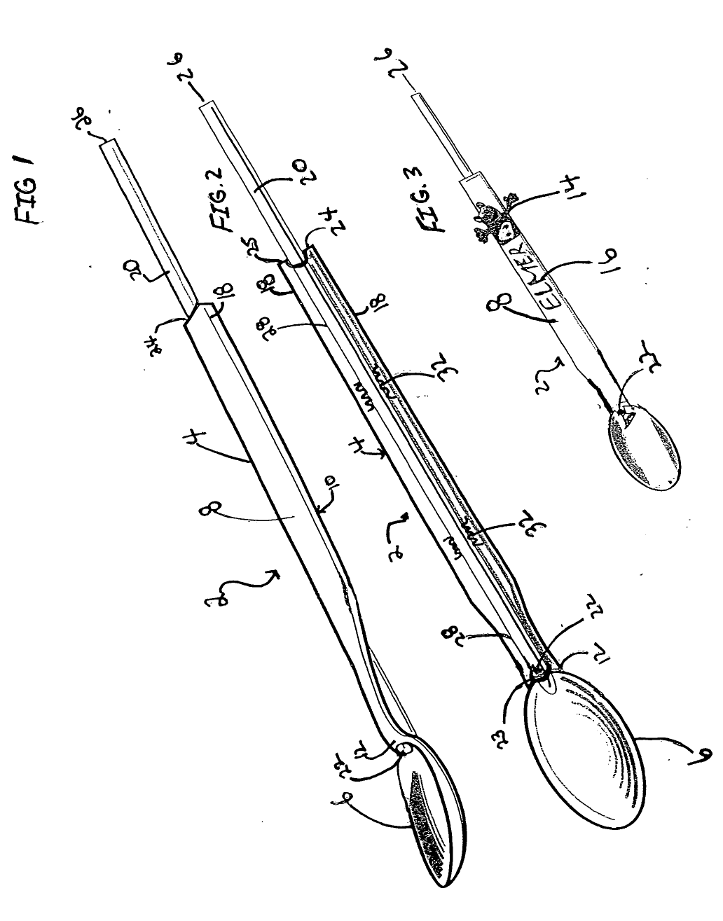

Turning first to FIG. 1, there is illustrated a hand held eating and drinking utensil, and more particularly a straw-spoon 2. The straw-spoon 2 is comprised of a solid handle 4, and a bowl 6. Solid handle 4 has a top side 8 and an underside 10. The bowl 6 is attached and extends from a first end 12 of the handle 4. The handle top side 8 may illustrate a picture, design or insignia, or any type of figure or design including but not limited to animals and human or fictitious characters. As shown FIG. 3, top side 8 can include a decorative FIG. 14 and/or writing 16 that can be permanently or temporarily attached to top side 8 by manufacturing procedures commonly known within the art. In the preferred embodiment of FIG. 1, the handle 4 is further provided with sidewalls 18 that act to form a channel-like configuration to the bottom side 10. In FIG. 1, straw 20 is seen as entering from the opening 22 at handle first end 12, past the second handle end 24, to straw end 26. Preferably the straw end 26 extends past the second handle end 24 by a distance ranging from about 2 to about 6 inches and more, preferably from about 2 to about 4 inches. In a paricullarly preferred embodiment, straw end 26 extends about 4 inches past solid handle end 24.

Turning to FIG. 2, there is seen the underside of the straw-spoon 2. The solid handle 4 is elongated with a channel 28 formed by sidewalls 18. The channel 28 extends from the handle first end 12 along the bottom side 10 of the entire length of the solid handle 4 to the handle second end 24. The backside of opening 22 is located on bottom side 10 at handle first end 12 and may enter at some position within the bowl 6. Preferably, the opening 22 is located at the point where the handle first end 12 connects with the bowl 6, and is capable of accommodating a straw 20 as it passes along the channel 28. The straw 20 can attach to hole 22 as a single molded unit. Alternatively, where there is not unitary construction, such as in the case of a removable straw, a means for sealing 23 the straw to hole 22 can be provided. Suitably means 23 can comprise a gasket, a hollow protrusion for tightly fitting into the straw or other known means of attaching tubing to reduce leakage. The straw 20 continues from the backside of opening 22 along the channel 28 beyond the second handle end 24 for the preferred distance. Preferably, the straw 20 is inserted into the solid handle 4 at the second handle end 24 through a support means 25 such as a U-shaped construction. It passes along the channel 28 and may be permanently held in place by any means as known within the art, such as by adhesive means. In an alternative preferred embodiment, the straw 20 is held in place by flexible structures 32 capable of bending to accommodate straws 20 of various diameters. As such, the flexible structures 32 can be made of a natural or synthetic material or any material known in the art, having a raised or finger like shape which protrudes from the side walls 18 into channel 28 along the bottom side 10 of the solid handle 4.

In an alternative embodiment of the invention, there is a permanently affixed straw 20 along the entire length of the channel 28 extending past the second end 24 the preferred distance from the solid handle 4.

Turning to FIG. 3, the assembly of the straw-spoon 2 as seen from the top can be more clearly described. The top side 8 may display a promotional name 16, or a decorative FIG. 14 may be attached by any means such as compression pins, clips, adhesive, or the like. Alternatively, the decorative FIG. 14 may be molded to the solid handle 8 during manufacture. Likewise, the promotional name 16 or an insignia may be molded into the top side 8 of the solid handle 4.

The decorative FIG. 14 is attached approximately at the mid-way portion of the top side 8 of solid handle 4 of the straw-spoon 2. The decorative FIG. 14 is positioned so that a user can hold the solid handle 4 and eat the food from the bowl 6 of the straw-spoon 2, or drink from the straw end 26.

It is recommended that the individual components be injection molded from a food grade plastic material. Furthermore, the plastic material should not be made of a plastic that is easily chipped or broken, due to the fact that users may bite on the bowl 6 and the handle 4. The plastic components should also have resiliency. The solid handle 4, channel 28, flexible structures 32, opening 12, the decorative FIG. 14, and the straw can be injection molded as one component. Preferably, the bowl 6 is to be injection molded integrally with the solid handle 4 portion of the straw-spoon 2 whether or not a decorative FIG. 14 is to be included.

Thus, there has been provided a straw-spoon which can be used as a spoon or a straw. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

What is claimed is:

1. A hand held eating and drinking utensil comprising:
a solid handle having a first end and a second end and a top side and a bottom side; and
a bowl integrally connected to the said handle first end and having an opening; and
a straw having a first end in fluid communication with said bowl opening and a second end extending past said handle second end.

2. The hand held eating and drinking utensil of claim 1 comprising a spoon and straw combination comprising:
a channel on the bottom side of said solid handle; and
said channel having side walls capable of housing and/or holding a straw.

3. The spoon and straw combination of claim 2 comprising:
flexible structures integral with said side walls within said channel and said opening of said bowl capable of flexing and providing a sealed communication with said straw.

4. The spoon and straw combination of claim 1 wherein said straw is fixed permanently within said channel and extends from said opening within said bowl through said channel running axially along said bottom side of said solid handle to said second end and continuing to extend past the handle second end by an amount ranging from about 2 to about 6 inches.

5. The spoon and straw combination of claim 1 wherein said solid handle is of an appropriate size for a child or adult to hold and said top side having a promotional area and a decorative figure connected to said top side promotional area.
